(19) United States
(12) Patent Application Publication
(10) Pub. No.: US 2013/0167738 A1
(43) Pub. Date: Jul. 4, 2013

(54) COMPACT BARBECUE

(71) Applicants: Denis Rochefort, Grezieu La Varenne (FR); Christophe Brouard, Craponne (FR); Marc Champion, Lyon (FR)

(72) Inventors: Denis Rochefort, Grezieu La Varenne (FR); Christophe Brouard, Craponne (FR); Marc Champion, Lyon (FR)

(73) Assignee: APPLICATION DES GAZ, Saint Genis Laval (FR)

(21) Appl. No.: 13/806,858

(22) PCT Filed: Jun. 20, 2011
(86) PCT No.: PCT/FR2011/051402

§ 371 Date: Feb. 15, 2013

(30) Foreign Application Priority Data
Jul. 1, 2010 (FR) 10/55273

(51) Int. Cl. A47J 37/07

(52) U.S. Cl. CPC A47J 37/0763
USPC 99/449

(57) ABSTRACT

The present invention relates to a compact barbecue, which can be connected to a cylinder or cartridge (2) of gas for cooking food, comprising a base (10), a combustion chamber (20) connected to the base (10) and including a front opening (23), a radiating gas burner (3) arranged inside the combustion chamber (20) opposite the front opening (23) thereof, characterized in that the barbecue (1) is foldable, the base (10) being movable relative to the combustion chamber (20), from a first so-called functional position (P1), in which the base (10) is arranged substantially transversely in relation to the combustion chamber (20) and ensures the stability of the barbecue (1) on the ground, and the front opening (23) of the combustion chamber (20) is cleared towards the outside, to a second so-called transport position (P2), in which the base (10) is arranged substantially longitudinally relative to the combustion chamber (20) and closes the opening (23) of the combustion chamber (20), wherein the combustion chamber (20) includes holding means (24) located near the front opening (23) and arranged to hold movable means (40) for supporting foods to be cooked opposite the radiating gas burner (3) when the barbecue(1) is in the functional position (P1) thereof.

### TECHNICAL FIELD

The present invention relates to a compact barbecue that can be connected to a gas cylinder or cartridge designed for cooking foods and having a combustion chamber with a radiant gas burner.

### BRIEF DISCUSSION OF RELATED ART

In a known manner, arranging a radiant burner has solved the problem that consisted of preventing grease from reaching the heating elements, which created toxic matter and smoke and caused flames to form that carbonized the food and altered its taste.

Nevertheless, this type of barbecue remains bulky and difficult to transport for people who are camping and wish to benefit from the advantages of cooking with a radiating burner.

This drawback is due on the one hand to the ergonomics, and primarily the dimensions and weight, of barbecues implementing this technology, and on the other hand the grease and smoke generated during cooking, which get the outside parts of the barbecue dirty, which can stain the user's clothing.

### BRIEF SUMMARY

The present invention aims to resolve all or some of the aforementioned drawbacks.

To that end, the present invention relates to a compact barbecue, which can be connected to a cylinder or cartridge of gas for cooking food, comprising a base, a combustion chamber connected to the base and including a front opening, a radiating gas burner arranged inside the combustion chamber opposite the front opening thereof, characterized in that the barbecue is foldable, the base being movable relative to the combustion chamber from a first so-called functional position, in which the base is arranged substantially transversely in relation to the combustion chamber and ensures the stability of the barbecue on the ground, and the front opening of the combustion chamber is cleared towards the outside, to a second so-called transport position, in which the base is arranged substantially longitudinally relative to the combustion chamber and closes the opening of the combustion chamber, wherein the combustion chamber includes holding means located near the front opening and arranged to hold movable means for supporting foods to be cooked opposite the radiating gas burner when the barbecue is in the functional position thereof.

This arrangement makes it possible to transport the barbecue easily so that it may be used anywhere. Furthermore, in its transport position, the outer portions remain relatively clean, which allows the barbecue to be transported while reducing the risks of dirtying the user's clothing.

According to one embodiment, the combustion chamber comprises a removable portion.

This arrangement allows easy cleaning of this part of the barbecue.

According to one embodiment, the removable portion includes a device for locking maintaining means.

This arrangement makes it possible to move the removable portion without risking the maintaining means falling and makes it possible to prevent the pins from coming out of their holding means when they are rotated.

According to one embodiment, the device for locking the maintaining means comprises an elongated member that can be moved from a first position prohibiting the maintaining means from coming out of their holding means to a second position allowing the maintaining means to come out of their holding means.

According to one embodiment, the device for locking the maintaining means comprises a device supported by the maintaining means having a shoulder translatable from a first position, in which the shoulder prevents the maintaining means from coming out of their holding means by cooperating with stop means, to a second position, in which the shoulder is released from the stop means, allowing the maintaining means to come out of their holding means.

According to one embodiment, the stop means include a stop positioned on a wall of the removable portion.

According to one embodiment, the stop means include a circular hole with a shape complementary to a circular portion of the shoulder.

Advantageously, the locking means assume the form of a rotatable lever relative to a wall of the removable portion, such as a flat bar.

Advantageously, the locking means assume the form of a translatable member relative to a wall of the removable portion, such as a flat bar.

According to the same embodiment, the position of the removable portion, once it is mounted on the barbecue, is chosen from among a first predetermined so-called close position, in which the removable portion is relatively close to the gas burner, and at least one second predetermined so-called remote position, in which the removable portion is relatively distant from the gas burner in relation to the closed position.

This arrangement makes it possible to have an additional means for regulating the cooking temperature of the food in addition to the typical regulation means consisting of regulating the gas flow supplying the burner.

It also makes it possible to predefine the cooking position as a function of the type of food to be cooked.

According to one embodiment, the removable maintaining means are pins rotatable inside the holding means and each include a driving means, such as a pinion, producing a meshing with the adjacent pin(s) so as to transmit a rotational movement.

This arrangement makes it possible to rotate all of the pins by rotating a single pin.

According to the same embodiment, the means for driving the pins producing the meshing are kept outside the front opening of the combustion chamber.

This arrangement makes it possible to preserve the pinions from deposits of grease and the majority of the heat produced by the burner, that heat being able to cause expansion phenomena of the pinion that could result in locking the rotational movement.

According to one embodiment, one of the pins is driven by an electric motor.

This arrangement makes it possible to obtain uniform cooking of the skewered foods without it being necessary to remain near the barbecue, for example to actuate a handle.

According to the same embodiment, the electric motor drives the pin including the driving means located closest to the center of the meshing.

This arrangement makes it possible to remove the end pins without the pins near the center ceasing the rotational movement.

According to one embodiment, the electric motor is placed outside the front opening of the combustion chamber on the side opposite the side on which the driving means of each of the pins are placed.

According to one embodiment, the removable maintaining means are formed by a double grate that can be used to cook foods such as meat, fish or bread.

According to one embodiment, the barbecue includes a profiled surface at the contour of the gas cartridge situated on the rear surface of its combustion chamber situated in a direction opposite its front opening.

This arrangement makes it possible to reduce cooling of the gas cartridge when the gas it contains is released into the expander or when there are low outside temperatures by better heating the gas cartridge, through radiation, conduction, and also convection, by means of the radiating burner located nearby.

According to one embodiment, the combustion chamber includes, on its rear surface, situated in the direction opposite its front opening, a compartment for storing a gas expander designed to store the gas expander when the latter is not connected to the gas cylinder or cartridge.

This arrangement makes it possible to improve the ergonomics of the barbecue during the transport thereof.

According to one embodiment, the barbecue includes catching means arranged to retain a gas expander on the rear surface of the combustion chamber, situated in a direction opposite its front opening.

This arrangement makes it possible to secure the gas cylinder or cartridge to the barbecue and makes it possible to heat the cold gas flowing under pressure in the expander.

According to one embodiment, the barbecue includes a locking means making it possible to keep the barbecue in its functional position.

This arrangement makes it possible to prevent untimely folding of the barbecue 1 into its transport position.

According to one embodiment, the barbecue includes locking means making it possible to keep the barbecue in its transport position.

This arrangement allows the barbecue to be transported completely safely by preventing untimely deployment of the barbecue toward its operational position.

According to one embodiment, the base includes a preparation and/or storage area when the barbecue is in its functional position.

This arrangement offers users a practical solution that keeps them from having to seek another preparation and/or storage area near the barbecue.

According to one embodiment, the combustion chamber includes, on the rear surface thereof, situated in a direction opposite its front opening, a transport handle making it possible to move the barbecue into its transport position, but also into its functional position.

This arrangement makes it possible to move the barbecue easily by minimizing the risks of burns and of tipping of the barbecue.

According to one embodiment, the barbecue includes a removable oil pan positioned substantially transversely in the bottom of the front opening of the combustion chamber when the barbecue is in its functional position, but also in its transport position.

This arrangement allows this element of the barbecue to be washed easily.

### BRIEF DESCRIPTION OF THE DRAWINGS

In any case, the invention will be well understood using the following description, in reference to the appended diagrammatic drawing showing, as a non-limiting example, a compact barbecue according to the invention.

FIG. 1 shows a perspective view on the front surface of the barbecue in its functional position.

FIG. 2 shows a perspective view on the front surface of the barbecue of FIG. 1 in its transport position.

FIG. 3 shows a view on the rear surface of the barbecue in its functional position.

FIG. 4 shows a side view of the barbecue in its functional position for a first application.

FIG. 5 shows a front view of the barbecue of FIG. 4.

FIG. 6 shows a perspective view on the front surface of the barbecue in its functional position for a second application.

FIG. 7 shows a view on the front surface of the barbecue of FIG. 1 in its transport position.

FIG. 8 shows a detailed view of the first embodiment of a part of the barbecue.

FIG. 9 shows a detailed view of a second embodiment of the same part of the barbecue illustrated in FIG. 8.

FIG. 10 shows a detailed view of a third embodiment of the same part of the barbecue illustrated in FIG. 8.

FIG. 11 shows another view of the third embodiment illustrated in FIG. 10.

FIG. 12 shows a detailed view of a fourth embodiment of the same part of the barbecue illustrated in FIG. 8 in the locking position.

FIG. 13 shows a detailed view of the fourth embodiment of the same part of the barbecue illustrated in FIG. 8 in the unlocked position.

FIG. 14 shows another view of the fourth embodiment illustrated in FIGS. 12 and 13.

FIG. 15 shows a detailed view of another part of the barbecue.

FIG. 16 shows another detailed view of part of the barbecue illustrated in FIG. 15.

### DETAILED DESCRIPTION

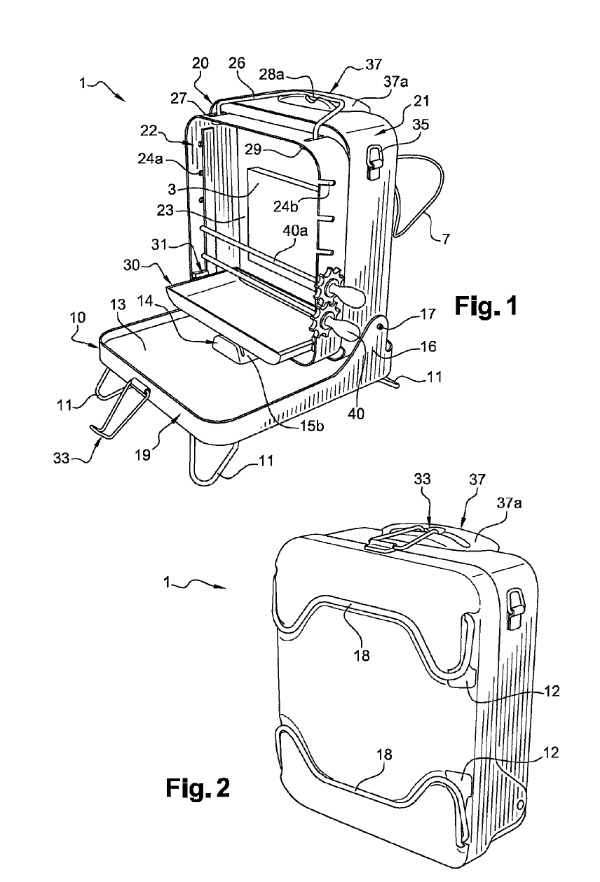

As illustrated in FIGS. 1 and 2, a barbecue 1 according to the invention comprises a base 10 connected to a combustion chamber 20 comprising a front opening 23.

In the rest of the description, the references to a spatial orientation are considered relative to the front opening 23 of the combustion chamber 20.

The base 10 has a substantially rectangular shape with a circumferential edge 19 substantially transverse to the main plane of the base 10.

The base 10 comprises four feet 11 ensuring the stability of the barbecue 1 on the ground. These four feet 11 are formed by two sintered round bars 18, preferably made from aluminum, each rotatable around an axle passing through the lateral flanks of the circumferential edge 19 of the base 10 from an unfolded position illustrated in FIG. 1, in which the feet ensure the stability of the barbecue 1 on the ground, to a folded position illustrated in FIG. 2, in which the two sintered round bars 18 are each kept in locations 12 formed in the thickness of the base 10 and with shapes complementary to the centering of the sintered round bars 18.

The base 10 is connected to the combustion chamber 20 by means of an axle 17 situated at the end of two portions 16 protruding from the circumferential edge 19 of the base 10 and situated near the bottom and back of the combustion chamber 20.

In this way, this axle 17 allows the rotation of the base 10 relative to the combustion chamber 20 from a first so-called functional position P1 illustrated in FIG. 1 to a second so-called transport position P2 illustrated in FIG. 2.

The combustion chamber 20 comprises two pullout portions, a main portion 21 connected by the axle 17 to the base 10 and a removable portion 22, the size of which allows it to be inserted in the main portion 21.

A radiating gas burner 3 is positioned on the back wall of the main portion 21 of the combustion chamber 20 across from the front opening 23.

In this functional position P1 of the barbecue 1, the removable portion 22 is maintained against the primary portion 21 on the one hand over its lower area by a blade 25, positioned substantially transversely from the outside of the lower contour of the removable portion 22, being inserted into a series of slots 15a, 15b of predetermined position arranged on a support block 14 fastened near the center of the base 10, and on the other hand on its upper area by a removable sintered round bar 26 maintained by clipping in a slot among two slots 28a, 28b formed over a first portion 37a of the multifunction block 37 arranged on the outer edge of the upper contour of the main portion 21 of the combustion chamber 20.

The multifunction block 37 with all of its functions is described in more detail a little later in the text.

The two ends of the sintered round bar 26 each pass through a slit 27 formed on the outer edge of the upper contour of the removable portion 22 of the combustion chamber 20 and form a pivot link while being partially inserted into an orifice formed on a portion 29 protruding from the inner edge of the upper contour of the removable portion 22 of the combustion chamber 20.

These two pivot links allow a rotation of the sintered round bar 26, and therefore heightwise travel of the median part of the sintered round bar 26 so as to position the removable portion in one or the other of the predetermined positions defined on the one hand by the position of the slots 15a and 15b arranged on the support block 14 fastened near the center of the base 10, and on the other hand by the slots 28a and 28b formed on the first portion 37a of the multifunction block 37.

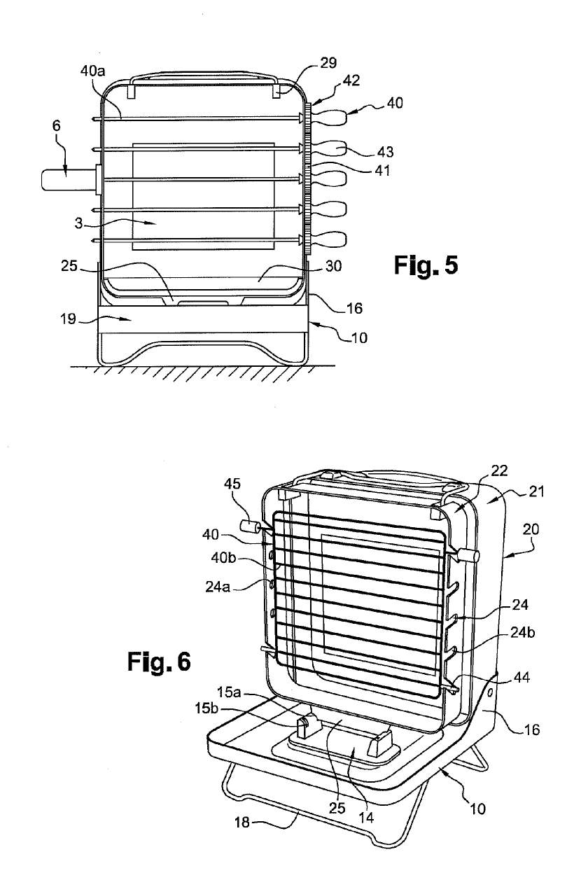

The removable portion 22 of the combustion chamber 20 comprises, on its lateral walls, holding means 24 for means for maintaining foods 40 such as pins 40a as illustrated in FIG. 5 or a grate 40b as illustrated in FIG. 6.

In the rest of the description, it will be considered that the pins 40a have a square profile, but they may have another profile, such as triangular, to improve the rotational driving of the foods on the pins 40a.

Furthermore, it is completely possible to consider mechanically rotating pins 40a having a triangular profile using driving means with a square profile, by putting two of the corners of the triangular profile in contact with two adjacent corners of the square profile and the third corner of the triangular profile with the middle of the side opposite the two sides of the square profile previously mentioned.

To that end, these holding means 24 are made up on a first of the two side walls of the removable part 22 by holes 24a for the passage of the end of the pins 40a or slits 24b for the passage of maintaining tabs 44 of the grate 40b, and on the second of the two walls by slits 24b for passage of the body of the pins 40a or maintaining tabs 44 for the grate 40b.

For usage comfort, certain maintaining tabs 44 of the grate 40b have a protective sheath 45 to prevent burns.

The holding means 24 also comprise a device 50 for locking the pins in their slits 24b.

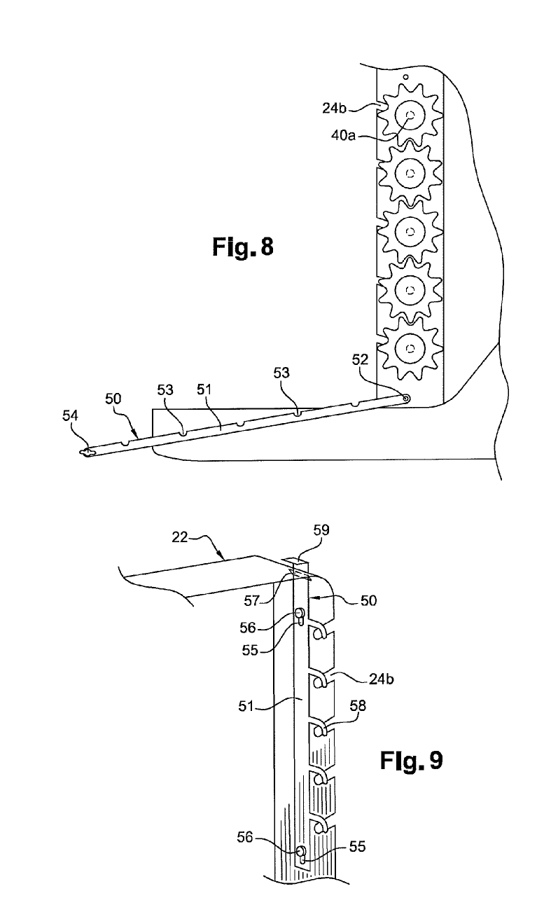

According to a first embodiment illustrated in FIG. 8, this locking device 50 comprises a flat bar 51 with a length greater than the distance separating the lowermost slit 24b from the uppermost slit 24b on the second of the two side walls of the removable part 22.

Each flat bar 51 is connected by a pivot link 52 situated below the lowermost slit 24b on the side wall of the removable portion 22 and slightly in front of the plane in which the pins 40a are aligned when they are placed in their respective holes 24a and slits 24b.

The locking device 50 also comprises a series of notches 53 arranged on a flank of the flat bar 51.

These notches 53 coincide with the slits 24b when the flat bar 51 is brought toward its vertical position using the pivot link 52.

The flat bar 51 is kept in that position using a fastener 54 embodied by a removable butterfly screw or any other locking device of the lever or bolt type.

In this position, the pins 40a are kept in their respective slit 24b using the flat bar 51 nevertheless situated at a sufficient distance from the bottom of the slits 24b not to prevent the rotation of the pins 40a.

According to a second embodiment illustrated in FIG. 9, this locking device 50 also comprises a flat bar 51 with a length longer than the distance separating the lowermost slit 24b from the uppermost slit 24b on the second of the two side walls of the removable portion 22.

This flat bar 51 is translatably slidingly mounted from a low position to a high position.

It is situated slightly behind the slits 24b and inside the side wall of the removable portion 22 on which those same slits 24b are formed.

The translational movement of this flat bar 51 is done by arranging, at both ends of the flat bar 51, two oblong holes 55 oriented vertically in which an axle 56 fastened to the inner side wall of the removable part 22 in a predetermined position slides.

The end of these two axles 56 is flattened so as to give them a width larger than the width of the oblong holes 55, thereby preventing the flat bar 51 from leaving one of the axles 56.

The amplitude of the translational movement of the flat bar 51 is defined by the length of the oblong holes 55 serving as stops for the two axles 56.

Due to its own weight, the flat bar 51 is in the low position by default.

To perform the translational movement, the upper end of the flat bar 51 passes through the wall of the removable part 22 through an opening 57 formed in the extension of the flat bar 51.

In order to facilitate its gripping, the flat bar 51 comprises, on its protruding portion of the removable part, a gripping means 59 for example formed by the curved end of the flat bar 51.

The locking device 50 also comprises a series of hooks 58 oriented downward and protruding from the flank of the flat bar 51 coinciding with the slits 24b when the flat bar 51 is in its low position and releasing the slits 24b when the flat bar is in its high position.

In the low position, the pins 40a are kept in their respective slit 24b using the hooks 58 of the flat bar 51, nevertheless situated at a sufficient distance from the bottom of the slits 24b to avoid preventing the rotation of the pins 40a.

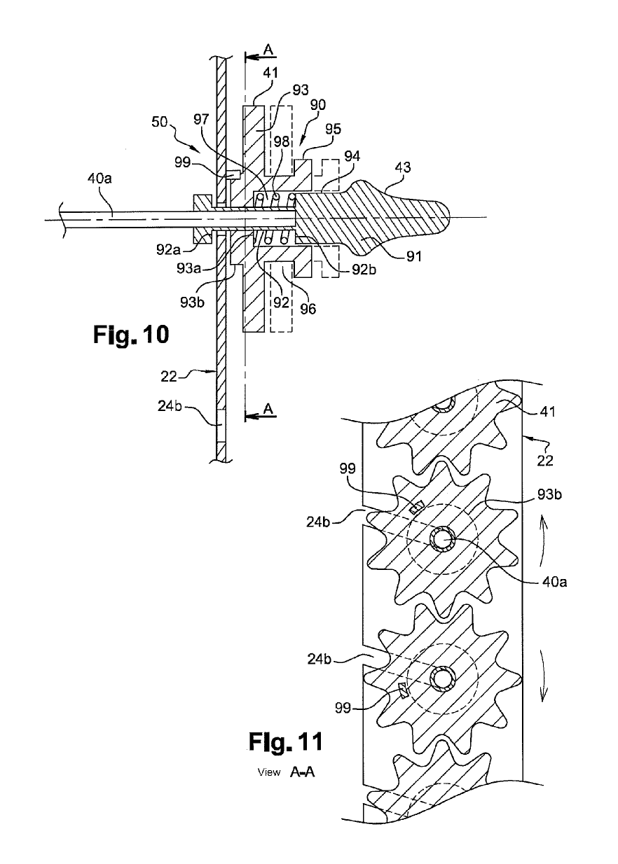

According to a third embodiment illustrated in FIGS. 10 and 11, this locking device 50 is a specific pin 40a equipped with a retractable pinion 41 device 90.

To produce this device 90, the handle 43 of the pins 40a comprises a body 91 in which an annular groove 92 is formed, being inserted into the slit 24b in which the pin 40a is inserted.

This annular groove 92 comprises an inner annular shoulder 92a located on the inner side of the removable part 22 of the combustion chamber 20 and an annular shoulder 92b located on the outer side of the removable part 22 of the combustion chamber 20.

On the side of said annular groove 92 placed on the outside of the removable part 22 of the combustion chamber 20, the body 93 of the pinion 41 is slidingly mounted while bearing on the one hand inside the annular groove 92 formed in the body 91 of the handle 43 by means of a shoulder 93a, and on the other hand on a guide portion 94 of the body 91 of the handle 43.

The height of the shoulder 93a is substantially the same as the depth of the annular groove 92.

In this way, the arrangement of the body 93 of the pinion 41 on the body 91 of the handle 43 creates a cylindrical chamber 97.

The cylindrical chamber 97 comprises a compressed helical spring 98 bearing on the one hand on the side of the shoulder 93a of the body 93 of the pinion 41, and on the other hand on the outer shoulder 92b of the annular groove 92 formed in the body 91 of the handle 43.

The length of the spring 98 is determined so as to preserve permanent play between the wall of the removable part 22 of the combustion chamber 20 located near the slit 24b in which the pin 40a is inserted and, on the one hand, the inner shoulder 92a of the body 91 of the handle 43, and on the other hand the annular shoulder 93b of the body 93 of the pinion 41 located between the wall of the removable part 22 and the pinion 41.

This annular shoulder 93b has a diameter larger than the width of the slit 24b and preferably smaller than the diameter of the pinion 41.

The body 93 of the pinion 41, on its end furthest from the wall of the removable part 22 of the combustion chamber 20, also comprises another annular shoulder 95 designed to form an annular space 96 around the body 93 of the pinion 41 for the passage of the user's fingers.

Lastly, the locking device 50 comprises a stop 99 protruding from the outer surface of the wall of the removable part 22 of the combustion chamber 20.

This stop 99 is placed near the slit 24b at a distance from the axis of rotation of the pin 40a slightly larger than the diameter of the shoulder 93b of the body 93 of the pinion 41.

The height of this stop 99 is larger than the total play created between the inner annular shoulder 92a and the annular shoulder 93b of the body 93 of the pinion 41 when the compressed helical spring 98 is in the idle position.

Furthermore, this stop 99 is placed on the side of the slit 24b first encountering a predetermined portion of the pinion 41.

Thus, for rotation of the pinion 41 in the trigonometric direction, the stop is placed on the upper side of the slit 24b. It is placed on the lower side when the pinion 41 moves in the anti-trigonometric direction. To insert the pins 40a into a slit 24b with a device 90 according to this third embodiment, the user also bears with his hand on the handle 43 of the pin 40a and inserts his fingers into the space 96 while bearing on the shoulder 95 of the body 93 of the pinion 41.

The user then pulls the body 93 of the pinion 41 toward him, which results in compressing the spring 98 and moving the inner annular shoulder 92a away from the annular shoulder 93b of the body 93 of the pinion 41, thereby making it possible to bring the pin 40a to the bottom of the slit 24b.

The user then releases the body 93 of the pinion 41.

In order to produce the meshing 42, the user repeats these operations for each of the pins 40a while making sure to engage the pinion 41 correctly one in the pinion 41 of the other.

During the rotational driving of one of the pins 40a, the latter part rotates the adjacent pin(s) 40a, but in the opposite direction.

The pins 40a, which normally tend to leave their respective slits 24b, are then kept therein owing to the action of the stop 99 on which the annular shoulder 93b of the body 93 of the pinion 41 abuts and slides.

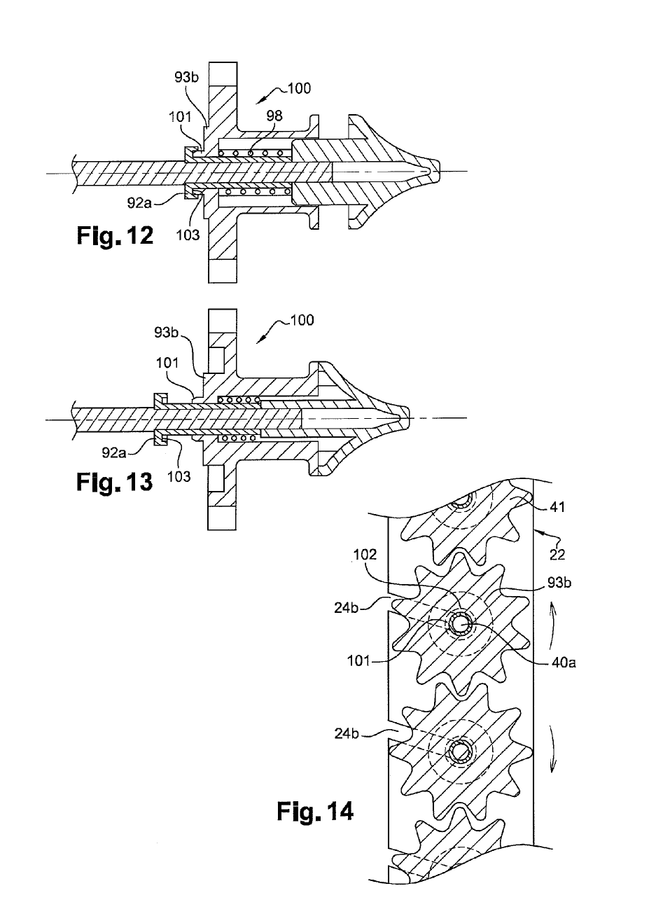

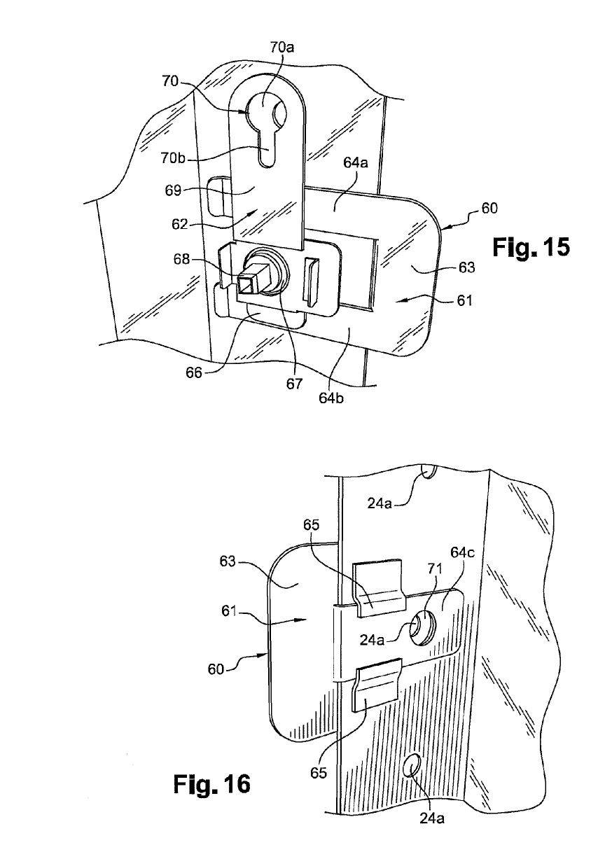

According to a fourth embodiment, shown in FIGS. 12 to 14 by a locking device 100, the body 93 of the pinion comprises, in addition to the third embodiment presented above, an annular shoulder 101 centered on the annular shoulder 93b.

This annular shoulder 101 has a width larger than the thickness of the wall of the removable part 22, such that in the locking position shown in FIG. 12, this annular shoulder 101 abuts against the annular shoulder 92a under the action of the spring 98.

In this locking position, and in order to center the annular shoulder 101 on the inner annular shoulder 92a, the latter part may include an annular slot 103 in which the end of the annular shoulder 101 is inserted.

To allow this annular shoulder 101 to pass through the wall of the removable part 22 so as to abut against the inner shoulder 92a, the slits 24b comprise an end in the form of a circular hole 102 centered on the axis of rotation of the pins 40a and with the same diameter with slight play as the diameter of the annular shoulder 101.

This circular hole 102 replaces the stop 99 presented in the third embodiment and performing the same stop function.

The sliding function of the annular shoulder 93b, during the rotation of the pins 40a, in a third embodiment is performed by the annular shoulder 101 that abuts and slides against the edges of the circular hole 102 formed in the slits 24b in this fourth embodiment.

In this fourth embodiment, the sizing of the spring 98 is less important than in the third embodiment due to the fact that the annular shoulder 101 abuts on the annular shoulder 92a and due to the fact that a permanent gap is maintained between the annular shoulder 93b and the inner annular shoulder 92a defined by the width of the annular shoulder 101.

This gap is larger than the thickness of the wall of the removable part and makes it possible to impart the necessary play to the rotational movement of the pins 40a in the slits 24b.

To insert the pin 40a into its slit 24b with a device 100 according to this fourth embodiment, the user proceeds in the same way as in the third embodiment.

The user bears with his hand on the handle 43 of the pin 40a and inserts his fingers into the space 96 while bearing on the shoulder 95 of the body 93 of the pinion 41.

The user then pulls the body 93 of the pinion 41 toward him, which results in compressing the spring 98 and moving the inner annular shoulder 92a away from the annular shoulders 101, 93b of the body 93 of the pinion 41, thereby making it possible to bring the pins 40a to the bottom of the slit 24b aligned with the circular hole 102.

The user then releases the body 93 of the pinion 41 so as to cause the annular shoulder 101 to penetrate the circular hole 102 until it abuts on the inner annular shoulder 92a.

In order to produce the meshing 42, the user repeats these operations for each of the pins 40a while making sure to engage the pinion 41 correctly with one in the pinion 41 of the other.

During the rotation of one of the pins 40a, said pin rotates the adjacent pin(s) 40a, but in the opposite direction.

The pins 40a, which normally tend to leave their respective slit 24b, are then kept therein owing to the action of the edge of the circular hole 102 on which the annular shoulder 101 of the body 93 of the pinion 41 abuts and slides.

Furthermore, being able to lock the pins 40a and even the double grate 40b for certain locking devices 50 allows the user to prepare, away from the barbecue 1, the arrangement of the means 40 for maintaining foods on the removable part 22, for example positioned horizontally on a flat surface, that allows the user to move the removable part 22 into a vertical position by grasping it by its sintered round bar 26 without fall risk for the food maintaining means 40.

In the first application of the barbecue 1 using pins 40a, the latter parts each include, on the first of their two ends, driving means embodied by a pinion 41 arranged transversely to the body of the pin 40a as well as a handle 43 extending that end of the pin 40a.

The second end of the pin 40a is inserted into a hole 24a or through a slit 24b on the first of the two side walls of the removable part 22 such that the pinion 41 of the pin 40a remains adjacent to the outer surface of the second of the two side walls of the removable part 22.

The diameter of the pinions, the size of the teeth of the pinions, and the spacing between the two adjacent holding means 24 is predetermined such that the arrangement of the set of pins forms a meshing 42 allowing the rotational driving of an adjacent pin.

In the various presented embodiments, all of the pinions 41 are identical, but it is nevertheless possible to consider having pins 40a having different pinion dimensions so as to obtain different speeds of rotation, making it possible to obtain different degrees of cooking doneness.

In this way, in a barbecue 1 using identical pins 40a, the rotational driving of the central pin 40a in one embodiment for example comprising five pins 40a, like that shown in FIGS. 4 and 5, will drive the rotation of two adjacent pins 40a at the same speed, which will in turn rotate two end pins 40a.

This rotation can be done manually using a commercially available removable handle (not shown) or using an electric motor 6 with removable batteries, as illustrated in FIG. 5, attaching to the outer surface of the first of the two side walls of the removable part 22 using a removable support device 60 illustrated in FIGS. 10 and 11 and outlined below.

The electric motor 6 includes, in a known manner, an off-center driving axle with a square profile and an edge situated at an adjustment distance from said driving axle serving to prevent the rotation of the electric motor 6 relative to the side wall of the barbecue 1.

The support device 60 comprises two parts 61, 62 connected to each other.

The function of the first part 61 is to position the support device 60 relative to the side wall of the removable part 22.

The purpose of the second part is to position the electric motor 6 relative to the first part 61.

The first part 61 comprises an elastic staple 63 made up of three tabs 64a, 64b and 64c.

The tabs 64a, 64b and 64c are engaged on the flank of the side wall of the removable part 22.

The tabs 64a and 64b are then on the outer side of the side wall of the removable part 22, while the tab 64c is on the inner side of that same side wall and is guided using two rails 65 securely arranged on either side of the central hole 24a of the holding means of the central pin 40a.

The tab 64c comprises an orifice 71 coinciding with the hole 24a of the holding means of the central pin 40a formed on the side wall of the removable part 22.

The end of each of the tabs 64a, 64b and 64c is slightly curved so as to facilitate their insertion on the flank of the side wall of the removable part 22 and to position tabs 64a, 64b and 64c having a high stiffness allowing solid maintenance of the support device 60 on the side wall of the removable part 22.

The second part 62 includes a U-shaped base 66, whereof the ends of the branches are welded to the staples 64a and 64b so as to move the base 66 away from the side wall of the removable part 22.

On this base 66, a hollow hub 67 is arranged freely rotating around an axle corresponding to the axle of the central pin 40a once the latter is positioned in its location on its holding.

This hollow hub 67 is maintained using two circlips arranged on either side of the base 66 and being inserted into transverse annular grooves formed in the hollow hub 67.

The hollow hub 67 has, at the center thereof, a hollow square tube 68 protruding transversely in the direction opposite the combustion chamber 20.

The square tube 68 has dimensions slightly larger than the square profile of the end of a pin 40a and slightly smaller than the off-center driving axle of square profile of the electric motor 6.

On the base 66, a platen 69 is also arranged extending upward parallel to the side wall of the removable part 22 beyond the height of the hole 24a formed in the side wall of the removable part 22 to maintain the pin 40a situated immediately above the central pin 40a.

The platen 69 comprises a passage 70 in the form of a key seat with a circular portion 70a having a large diameter and an oblong portion 70b having a width smaller than the diameter of the circular portion 70a.

The circular portion is aligned coaxially with the hole 24a formed in the side wall of the removable part 22 to keep the pins 40a situated immediately above the central pin 40a.

The oblong portion 70b is arranged below the circular portion 70a.

To use the motorized rotation of the pins 40a, the user begins by grasping the support device 60 of the electric motor 6, on which he inserts the off-center driving axle of square profile of the electric motor 6 into the square tube 68 as well as its stop by the circular portion 70a.

He then slides the stop into the oblong portion 70b, then positions the support device 60 of the electric motor 6 on the side wall of the removable part 22.

In order to prevent a longitudinal shift of the pins 40a, the latter include a ring with a circular section having two lateral flanges between which the notches 53 or the hooks 58 are inserted, depending on the embodiment used.

As illustrated in FIG. 4, in its functional position P1, the barbecue 1 provides a preparation and/or storage area 13 after cooking for two additional pins 40a.

Being stored near the burner 3, these two additional pins 40a remain hot for a longer period of time.

In the bottom of the combustion chamber 20, transverse to the main part 21 and removable part 22, a removable oil pan 30 is also provided maintained by rails 31 arranged on the inner wall of the movable part 22.

These rails 31 allow horizontal translational movement of the removable pan 30 so as to allow the release thereof for possible washing, for example.

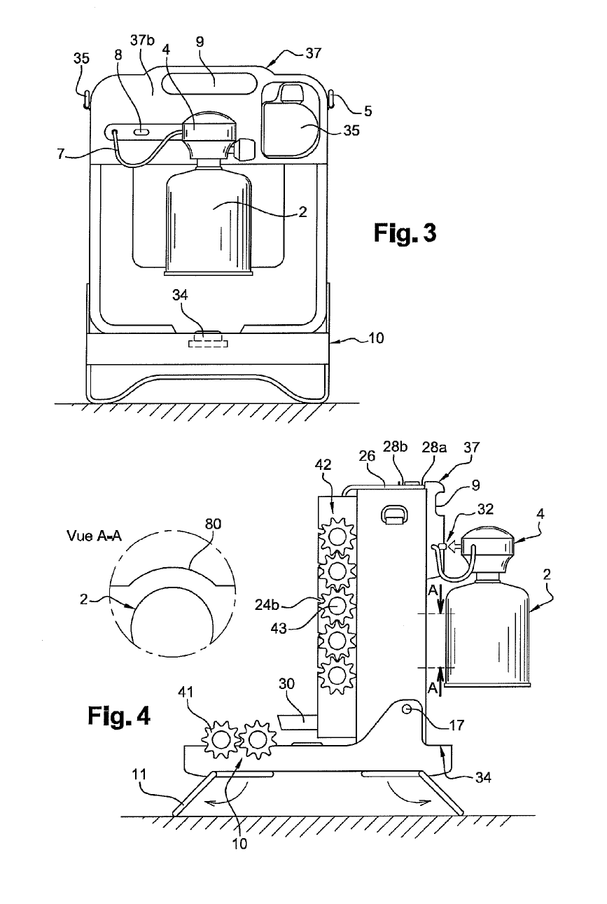

As illustrated in FIG. 3, at the back of the combustion chamber 20, the ignition and supply elements for the radiating burner 3 are provided.

The multifunction block 37 is made to be unitary in a single piece, preferably made from hard molded plastic resistant to high temperatures, and comprises the first portion 37a arranged on the outer edge of the upper contour of the main part 21 of the combustion chamber 20 as well as a second portion 37b arranged substantially transverse to the first portion 37a and covering a whole upper part of the back of the main part 21 of the combustion chamber 20.

This multifunction block 37 is preferably maintained by clipping against the main part 21 of the combustion chamber 20 preferably made from sheet metal, but it is obvious to one skilled in the art that this can be fastened to the main part 21 of the combustion chamber 20 using any other equivalent means, for example such as screws.

A piezoelectric ignition button 8 producing a spark on the outer heating surface of the radiating burner 3 protrudes from the second portion 37b of the multifunction block 37.

The second portion 37b of the multifunction block 37 also comprises a handle 9 molded in the multifunction block allowing a user to move the barbecue 1, whether it is in the transport position P2 or the functional position P1.

Likewise, the second portion 37b of the multifunction block 37 comprises a hole for the passage of a flexible hose 7 for supplying gas connecting the radiating burner 3 to a gas expander 4 as well as a compartment 5 molded with the multifunction block 37 serving to store the gas expander 4 when the latter is not connected to a gas cylinder or cartridge 2.

The gas expander 4 includes a connecting device performing the dual function of expander and tap and easily connecting to a gas cartridge 2 in the manner described in patent EP0981005 or patent application EP1802908.

When the gas expander 4 is connected to a gas cylinder or cartridge 2, a catching means 32 is provided for the expander on the second portion 37b of the multifunction block 37.

This catching means 32 may for example be made by a dovetail or the arrangement of the rail positioned on the second portion 37b of the multifunction block 37 and a guide channel with a shape complementary to that of the rail arranged on the gas expander 4 or vice versa.

This may for example also be done by one or two emerging orifices (not shown) of the key seat type formed on the second portion 37b of the multifunction block 37 comprising a circular upper portion with a diameter larger than that of one or two screw heads positioned on the gas expander 4 and an oblong lower portion with a width smaller than the screw head(s) so as to retain the gas expander 4 when the screw heads of the screws slide from the upper part toward the lower part of the orifice.

The same catching means 32 are also present in the compartment 5 so as to maintain the gas expander 4 therein during transport when said gas expander is not connected to a gas cartridge 2.

Once attached, the gas cartridge 2 comes into contact with a profiled surface 80 situated at the back of the combustion chamber 20 shown in FIG. 4 by view A-A on the back of the barbecue 1.

This profiled surface 80 reduces the cooling of the gas cartridge 2 during the release of the gas it contains into the expander 4 or during low outside temperatures by better heating the gas cartridge 2, by radiation, conduction, as well as convection, by means of the radiating burner 3 located nearby.

As illustrated in particular in FIGS. 3 and 4, on the part of the base 10 protruding on the back of the main part 21 of the combustion chamber 20 when the barbecue 1 is in its functional position P1, a locking means 34 is provided locking the barbecue 1 in its functional position P1, thereby preventing untimely folding of the barbecue 1 toward its transport position P2.

In a known manner, this locking means 34 may for example include a spring button connected to a blade bearing on the main part 21 of the combustion chamber 20 when the barbecue is in its functional position P1.

Likewise, the barbecue 1 also comprises a locking means 33 locking the barbecue 1 in its transport position P2, thereby preventing untimely deployment of the barbecue 1 toward its functional position P1.

These locking means 33, as illustrated in FIGS. 1 and 2, are formed here by elastic hooks connected to the front outer contour of the edge 19 of the base 10 by an end freely rotating around fastening points to the base 10, while the other end clips in the slot 28b formed on the first portion 37a of the multifunction block 37.

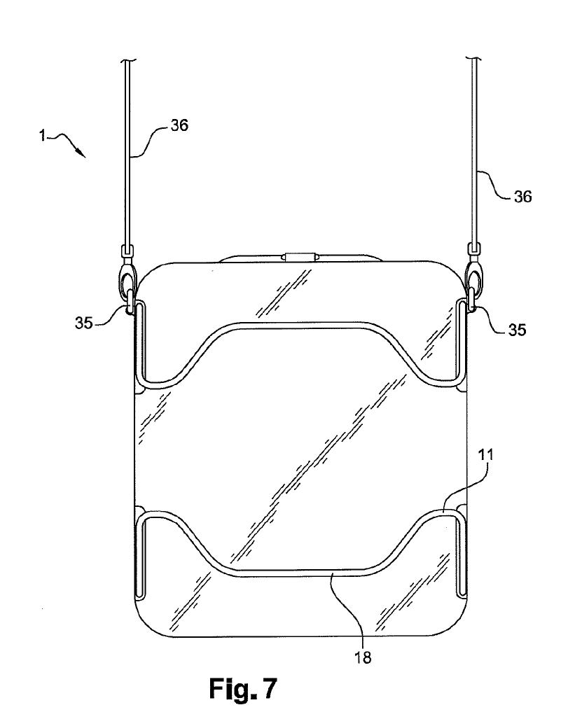

For transport, as illustrated in FIG. 7, transport rings 35 are also provided arranged on the upper area of the outside of the side walls of the main part 21 of the combustion chamber 20, as well as a removable strap 36 attaching the two transport rings 35 in a known manner.

The user of the barbecue 1 can thus transport the barbecue 1 on one of his shoulders.

When the user wishes to use the barbecue 1, he begins by choosing a location favorable for use of the barbecue 1, preferably an uncluttered location outdoors.

He then places the barbecue 1 on the ground and detaches the strap 36 from the two transport rings 35.

He then unfolds the four feet 11 by unclipping the two round bars 18 from their locations 12 formed in the base 10, then the rotates them until they abut against the base 10.

The user then detaches the elastic hook 33 and tilts the main part of the combustion chamber 20 toward the functional position P1 of the barbecue 1 until the locking means 34 indicate that the barbecue is in that functional position. This indication may be visual or auditory.

In this step, the removable part 22 of the combustion chamber 20 is embedded inside the main part 21 and the pins 40a are stored diagonally in the removable part 22.

The user then begins by removing the removable part 22, the oil tray 30, the pins 40a, which may for example be positioned on the preparation and/or storage area 13, as well as potentially the removable electric motor 6 and its support device 60.

The sintered round bar 26 of the removable part 22 is potentially retained by an elastic tab (not shown) arranged inside the main part 21 of the combustion chamber 20 to prevent the sintered round bar 26 from moving and creating noise during transport of the barbecue 1.

The removable part 22 is placed flat on a flat surface.

After having prepared the pins 40a with a double grate 40b by attaching food thereto, the user positions them on the holding by first inserting the end of the pins 40a into the holes 24a, then returning the body of the pins 40a into the slits 24b while taking care to align the set of pinions 41 of the pins 40a so as to form the meshing 42.

The user then ensures that the slits 24b are closed using the locking device 50.

He then potentially installs the electric motor 6, then installs the removable part 22 of the combustion chamber 20 on the barbecue 1.

The central pin 40a of square profile is then inserted into the driving axle of square profile of the electric motor 6.

In order to position the removable part 22 on the barbecue 1, he grasps the bottom of the removable part and places the blade 25 inside one of a series of slots 15a, 15b of the support block 14 and attaches the sintered round bar 26 on the appropriate slot among the slots 28a, 28b formed on a first portion 37a of the multifunction block 37 so as to stabilize the removable part 22 of the combustion chamber 20.

The user then takes the gas expander 4 out of its compartment 5, and connects a gas cartridge 2 to said expander.

He then attaches the gas expander 2 using attaching means 32, opens the tap situated on the gas expander 2, then pushes on the piezoelectric button to ignite the radiating burner 3.

The user then need only start the electric battery motor 60 to rotate the set of pins 40a.

The grease from the foods is then recovered in the tray 30 provided to that end.

At the end of cooking, the user turns off the gas supply using the tap situated on the gas expander 2 and stops the rotation of the pins 40a by stopping the electric motor 6.

After having washed all of the removable parts, such as the oil tray 30, the removable part 32 of the combustion chamber 30, and the pins 40a, the user proceeds with the same steps in the reverse order to bring the barbecue into its transport position P2.

It should be noted that if it is not empty, the gas cartridge 2 may remain attached to the barbecue 1 without this hindering its transport.

The dimensions of this compact barbecue 1 make this barbecue 1 a device that is easy to use and transport with a reduced bulk.

For information regarding the bulk of a barbecue 1 according to the invention, in the functional position P1, the height of the feet 11 positions the base 10 at 5 cm from the ground for a total height smaller than 45 cm, a depth smaller than 43 cm, and a width smaller than 35 cm.

Although the invention has been described relative to specific embodiments, it is of course in no way limited thereto and encompasses all technical equivalents of the described means as well as their combinations.

1. A compact barbecue, which can be connected to a cylinder or cartridge of gas for cooking food, comprising:
a base,
a combustion chamber connected to the base and including a front opening,
a radiating gas burner arranged inside the combustion chamber opposite the front opening thereof,
wherein the barbecue is foldable, the base being movable relative to the combustion chamber from a first so-called functional position, in which
the base is arranged substantially transversely in relation to the combustion chamber and ensures the stability of the barbecue on the ground, and
the front opening of the combustion chamber is cleared towards the outside,
to a second so-called transport position, in which:
the base is arranged substantially longitudinally relative to the combustion chamber and closes the opening of the combustion chamber,
the combustion chamber including holding means located near the front opening and arranged to hold movable means for supporting foods to be cooked opposite the radiating gas burner when the barbecue is in the functional position thereof.

2. The barbecue according to claim 1, wherein the combustion chamber comprises a removable portion.

3. The barbecue according to claim 2, wherein the removable portion includes a device for locking maintaining means.

4. The barbecue according to claim 3, wherein the device for locking the maintaining means comprises an elongated member that can be moved from a first position prohibiting the maintaining means from coming out of their holding means to a second position allowing the maintaining means to come out of their holding means.

5. The barbecue according to claim 3, wherein the device for locking the maintaining means comprises a device supported by the maintaining means having a shoulder translatable from a first position, in which the shoulder prevents the maintaining means from coming out of their holding means by cooperating with stop means, to a second position, in which the shoulder is released from the stop means, allowing the maintaining means to come out of their holding means.

6. The barbecue according to claim 5, wherein the stop means include a stop positioned on a wall of the removable portion.

7. The barbecue according to claim 5, wherein the stop means include a circular hole with a shape complementary to a circular portion of the shoulder.

8. The barbecue according to claim 2, wherein the position of the removable portion, once it is mounted on the barbecue comprises a first predetermined so-called close position, in which the removable portion is relatively close to the gas burner, and at least one second predetermined so-called remote position, in which the removable portion is relatively distant from the gas burner in relation to the closed position.

9. The barbecue according to claim 1, wherein the removable maintaining means are pins rotatable inside the holding means and each include a driving means producing a meshing with the adjacent pin(s) so as to transmit a rotational movement.

10. The barbecue according to claim 1, including a profiled surface at the contour of the gas cartridge situated on the rear surface of its combustion chamber, situated in a direction opposite its front opening.

11. The barbecue according to claim 1, wherein the combustion chamber includes, on its rear surface, situated in the direction opposite its front opening, a compartment for storing a gas expander designed to store the gas expander when the latter is not connected to the gas cylinder or cartridge.

12. The barbecue according to claim 1, including catching means arranged to retain a gas expander on the rear surface of the combustion chamber, situated in a direction opposite its front opening.

13. The barbecue according to claim 1, including locking means making it possible to keep the barbecue in its functional position.

14. The barbecue according to claim 1, wherein the base includes a preparation and/or storage area when the barbecue is in its functional position.

15. The barbecue according to claim 1, wherein the combustion chamber includes, on the rear surface thereof, situated in a direction opposite its front opening, a transport handle making it possible to move the barbecue into its transport position, but also into its functional position.
